(19) United States
(12) Patent Application Publication
(10) Pub. No.: US 2024/0406173 A1
(43) Pub. Date: Dec. 5, 2024

(54) SYSTEM FOR AUTOMATED PROCESS SUBSTITUTION WITH CONNECTION-PRESERVING CAPABILITIES

(71) Applicant: U.S. Army DEVCOM, Army Research Laboratory, Adelphi, MD (US)

(72) Inventor: Jaime C. Acosta, El Paso, TX (US)

(21) Appl. No.: 18/427,030

(22) Filed: Jan. 30, 2024

Related U.S. Application Data
(60) Provisional application No. 63/471,171, filed on Jun. 5, 2023.

(51) Int. Cl. H04L 9/40

(52) U.S. Cl. CPC H04L 63/10; H04L 63/1491

(57) ABSTRACT

A networked computer system for automated substitution process with reserved connection capabilities. The networked computer system includes a profiler component that collects information about a candidate process and generates a configuration file; a checkpoint generator component that instantiates, suspends, and stores information for execution of the candidate process and creates a checkpoint based on the configuration file; and an orchestrator component that receives the checkpoint and a transition configuration to manage and enact a substitution process for the candidate process for counteracting unauthorized use of predetermined data in the network while maintaining all network connections during execution of the substitution process.

### CROSS-REFERENCE TO RELATED APPLICATIONS

This application claims priority to U.S. Provisional Ser. No. 63/471,171, filed on Jun. 5, 2023, the complete disclosure of which, in its entirety, is herein incorporated by reference.

### GOVERNMENT INTEREST

The embodiments herein may be manufactured, used, and/or licensed by or for the United States Government without the payment of royalties thereon.

### BACKGROUND

### Technical Field

The embodiments herein generally relate to cybersecurity technologies, and more particularly to computer networking systems that manage access to resources and processes in a network.

### Description of the Related Art

This background description includes information that may be useful in understanding the present invention. It is not an admission that any of the information provided herein is prior art or relevant to the presently claimed invention or that any publication specifically or implicitly referenced is prior art.

Defenders typically introduce additional artifacts, called honeypots, in the network to lure attackers away from legitimate assets and to understand their techniques and motivations. Honeypots can range in fidelity from low-interaction, such as a simple listener, to high-interaction, such as a full webserver. The choice in fidelity is largely influenced by available resources. For this reason, conventional solutions have looked at how to strategically place these honeypots to maximize their utility. However, it is infeasible to calculate every move an attacker may take; due to the possibility of there being multiple attackers or changes in intentions.

Depending on an attacker's intent and motivation, they use different techniques to understand their target domain. This is the first stage in the attack lifecycle. Various tools are used during this stage to uncover devices, services, and specific versions of those services. This information can then be used to better plan and execute the next stages of the lifecycle. FIG. 1 shows some of the basic steps of a typical Nmap® (Network Mapper) scan against a single target. The depth of a scan depends on the options supplied to the Nmap® network scanner. FIG. 1 shows three levels depth: Host Discovery (A), Service Probe (B), and Service/Version Detection (C). During the Host Discovery phase (A) a target is identified by sending Internet Control Message Protocol (ICMP) packets as well as synchronization (SYN) and acknowledgement (ACK) packets that target Hypertext Transfer Protocol Secure (HTTPS) (or Transport Layer Security (TLS)) and Hypertext Transfer Protocol (HTTP) services. These are two of the most commonly used services on the Internet. If the target is up, it typically responds to some of these requests. In the case when a Transmission Control Protocol (TCP) port is found to be in a listening state, a service probe will establish a connection to the target on the port. Finally, if a user chooses to conduct version detection, Nmap® network scanner will additionally attempt to interact with the service to uncover its version. As the scan increases in depth, there is a potential to gain more information, but at the cost of stealth. An efficient way to manage a honeypot would be to start with a simple, low-resource listener. This listener would stay active during a Host Discovery Service Probe, but would suspend and switchover to a higher-fidelity honeypot after a TCP handshake (Service/Version Detection). The switchover must be seamless and undetectable from a remote device, so as to not alert an adversary.

Dynamic honeypot instantiation has been a focus area in cybersecurity for over two decades. Some examples include a system that dynamically configures low-fidelity and low-interaction Honeyd honeypots based on identified Nmap® scans. More recently, the Cybersecurity Deception Experimentation System (CDES) was built to enable dynamic traffic redirection and instantiation of various types of honeypot technologies. A performance study demonstrated that this approach is fast enough to successfully redirect Nmap® probes when instantiating both kernel network namespaces and virtual machines. To use resources more efficiently and to provide better defense agility, honeypots need to be able to adapt; to transition across different levels of fidelity.

Related to connection hand-off techniques, conventional solutions have succeeded in switching from low-to high-interaction honeypots across devices by using proxies and traffic replays. Subsequent solutions targeted the identical-fingerprint problem (which requires that the high-interaction honeypot match both Internet Protocol (IP) and Operating System (OS) of the low-interaction honeypot). Newer implementations use Software-Defined Networking (SDN) for redirection. However, these approaches redirect traffic to remote systems. Issues with some of these approaches include overhead, network delays, and possible availability concerns caused by the need to forward traffic to another machine. The high-interaction honeypots are either in a persistent up-state or they have to be booted from a stop-state. Traffic replay is required to match the existing session, which may be non-trivial, e.g., in cases when operating systems differ. Additionally, setup, configuration, and maintenance may become overly complex, and the resources required for these systems to work may not be feasible in constrained environments.

The attack lifecycle starts with the intelligence gathering stage. Network scanning tools are commonly used during this stage to enumerate devices and their services. These tools may be used in various ways depending on the adversary's motivations. The trade-off is between stealth and potential information gain. Some tools may simply identify live hosts, while others may fully connect to remote devices and interact with their services. Traditionally, the choice of honeypot deployment locations and their fidelity are mostly static and they rely on an abundance of resources for hosting and redirection. This is inefficient and, especially in resource-constrained environments, not suitable. Accordingly, technologies that enable efficient and adaptive honeypots are critical.

### SUMMARY

In view of the foregoing, an embodiment herein provides a networked computer system for automated substitution process with reserved connection capabilities, the networked computer system comprising a profiler component that collects information about a candidate process and generates a configuration file; a checkpoint generator component that instantiates, suspends, and stores information for execution of the candidate process and creates a checkpoint based on the configuration file; and an orchestrator component that receives the checkpoint and a transition configuration to manage and enact a substitution process for the candidate process for counteracting unauthorized use of predetermined data in the network while maintaining all network connections during execution of the substitution process.

The profiler component extracts key information about the candidate process by executing the candidate process and analyzing system calls associated with file and network actions during execution. The profiler component generates a configuration file that includes network and file descriptor information. The configuration file may be defined by a unique identifier element to keep track of processes, configurations, and associated data; a commands element to be executed before the processes; a binary or script element to instantiate the processes; a first path element to identify a location of a checkpoint/restore in userspace (CRIU®) binary; and a second path element to identify where the CRIU® binary is to be executed.

The profiler component may comprise a process instantiator that executes the candidate process; a process interactor that establishes a simple network connection with the candidate process to reveal specific file descriptors associated with the established network connection or connections; and an artifact extractor that stores the specific file descriptors associated with the established network connection or connections to client devices so that subsequent phases are able to pinpoint particular information required for a transition to the substitution process. The process interactor logs system calls executed by the candidate process. The system calls include network socket system calls which are parsed to obtain information about listening ports and listening interface addresses. The checkpoint generator component creates the checkpoint by suspending the candidate process and storing all data that is required to resume the candidate process at a later time.

The checkpoint may be defined by a unique identifier element that matches a unique identifier specified in the candidate process; a port element that the checkpoint utilizes for network communication; a directive element that indicates whether checkpoint data should be overwritten if a target directory is not empty; and a method element that identifies whether a time-based or automatic checkpoint type occurs. The checkpoint may be defined by a connection element that specifies whether a network connection should gracefully close after the checkpoint; a store element that identifies a location where checkpoint data will be stored; a template element that identifies a location of a template that will be used to generate a script for creating the checkpoint; a converter element that identifies a location of a software program to convert specific checkpoint files from one data interchange format to another; a weaver element that identifies a location of the software program that transfers network socket information across checkpoints; a script element that identifies a location where an auto-generated checkpoint execution script will reside; a command element that isolates and extracts an identification of a running process; and a delay element that identifies a duration before the checkpoint is selected. The checkpoint may be defined by a template element that identifies a location of a template engine that will be used to generate the code for a pre-load library source file; a first trigger element that identifies system calls that will be overridden and that will potentially checkpoint the process, depending on whether a file descriptor matches; a second trigger element that identifies file descriptors that will be compared within system call functions to determine whether the process should be checkpointed; a compile element that determines whether to compile a generated library if a binary already exists; a checkpoint element that specifies, in the case of multiple system call and file descriptor matches, which iterations the checkpoints should be taken; and a library element that identifies a location where the pre-load library source file will be stored.

The checkpoint generator component may comprise an environment constructor that reads file descriptors associated with an established network connection or connections to a client device complied by the profiler component and generates at least one directory that will be used to store time-based and automatic checkpoints for the candidate process; a code generator that creates an execution script for the candidate process; an interaction process that connects to the candidate process to checkpoint in a connected state; and a checkpoint creator that runs the execution script for the candidate process. The code generator uses a template engine to create the execution script. The code generator creates an auto-interrupter program that overrides system call functions, which is compiled into a library that is pre-loaded into a target candidate process. The candidate process and the substitution process for the candidate process may comprise honeypots. The honeypots may comprise decoy devices or services or a combination thereof operating on the network that are used to lure attackers away from the predetermined data.

The orchestrator component handles an instantiation and transition of a substitution process for the candidate process when specified conditions are met based on time or system calls. The orchestrator component interweaves data across processes that are needed to preserve network connections. The orchestrator component may comprise a code generator that creates a switchover script for executing the substitution process for the candidate process; a honeypot instantiator that executes the switchover script; a trigger that analyzes the executed switchover script and determines and stores information about a current network state of the network; and a process weaver that retrieves information regarding at least one previous target and updates a socket to match that of a current process.

Another embodiment provides a computer-readable medium storing instructions for automated substitution process with reserved connection capabilities, the instructions executed by a processor to collect information about a candidate process and generate a configuration file; instantiate, suspend, and store information for execution of the candidate process and create a checkpoint based on the configuration file; and receive the checkpoint and a transition configuration to manage and enact a substitution process for the candidate process for counteracting unauthorized use of predetermined data in the network while maintaining all network connections during execution of the substitution process.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic diagram illustrating sample of steps during an Nmap® scan;

FIG. 2A is a block diagram of a computer system, according to an embodiment herein;

FIG. 2B is a process data flow diagram for operating the computer system of FIG. 2A, according to an embodiment herein;

FIG. 3A is a block diagram illustrating aspects of the profiler component, according to an embodiment herein;

FIG. 3B is a process data flow diagram for operating the profiler component of FIG. 3A, according to an embodiment herein;

FIG. 4A is a block diagram illustrating aspects of the checkpoint generator component, according to an embodiment herein;

FIG. 4B is a process data flow diagram for operating the checkpoint generator component of FIG. 4A, according to an embodiment herein;

FIG. 5 is a block diagram illustrating a honeypot used in the computer system of FIG. 2A, according to an embodiment herein;

FIG. 6A is a block diagram illustrating aspects of the orchestrator generator component, according to an embodiment herein;

FIG. 6B is a process data flow diagram for operating the orchestrator generator component of FIG. 6A, according to an embodiment herein;

FIG. 7 is a block diagram illustrating a system executing computer-executable instructions for an automated substitution process with reserved connection capabilities, according to an embodiment herein; and

FIG. 8 is a block diagram illustrating a computer system, according to an embodiment herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. The following description of particular embodiment(s) is merely exemplary in nature and is in no way intended to limit the scope of the invention, its application, or uses, which can, of course, vary.

It will be understood that when an element or layer is referred to as being “on”, “connected to”, or “coupled to” another element or layer, it may be directly on, directly connected to, or directly coupled to the other element or layer, or intervening elements or layers may be present. In contrast, when an element or layer is referred to as being “directly on”, “directly connected to”, or “directly coupled to” another element or layer, there are no intervening elements or layers present. It will be understood that for the purposes of this disclosure, “at least one of X, Y, and Z” or “any of X, Y, and Z” may be construed as X only, Y only, Z only, or any combination of two or more items X, Y, and Z (e.g., XYZ, XY, XZ, YZ).

The description herein describes inventive examples to enable those skilled in the art to practice the embodiments herein and illustrates the best mode of practicing the embodiments herein. Upon reading the following description in light of the accompanying drawing figures, those skilled in the art will understand the concepts of the disclosure and will recognize applications of these concepts not particularly addressed herein.

The terms first, second, etc. may be used herein to describe various elements, but these elements should not be limited by these terms as such terms are only used to distinguish one element from another. For example, a first element could be termed a second element, and, similarly, a second element could be termed a first element, etc. without departing from the scope of the present disclosure. As used herein, the term “and/or” includes any and all combinations of one or more of the associated listed items.

Furthermore, although the terms “final”, “first”, “second”, “upper”, “lower”, “bottom”, “side”, “intermediate”, “middle”, and “top”, etc. may be used herein to describe various elements, but these elements should not be limited by these terms. These terms are only used to distinguish one element from another. For example, a first element could be termed an “top” element and, similarly, a second element could be termed a “top” element depending on the relative orientations of these elements.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used herein, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

The embodiments herein provide a system for networked computer system for automated substitution process with reserved connection capabilities, which is capable of switching across different processes based on either time or on observed system calls. In either case, the switchover occurs across processes on a local device (it does not require additional networked assets, e.g., for traffic redirection) and connections are not severed; their properties are carried over. The configuration specifications used by the system include examples for switching from a low-interaction honeypot to full services. The embodiments herein further describe an evaluation of the system against the Nmap® tool and several legitimate client applications, including a timing analysis based on Nmap® reports. The system attempts to alleviate some of these issues by using process checkpoints, automating setup and configuration processes, and hosting the multi-fidelity honeypots on the local device. Accordingly, the system is capable of switching between multi-fidelity honeypots on a local device, on-the-fly, and it preserves network session data. The design of the mechanism focuses on automation and flexibility through its use of configuration files and code templates.

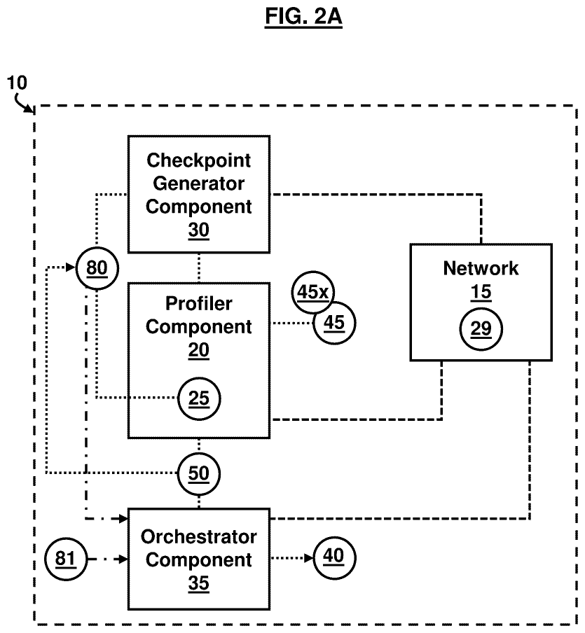

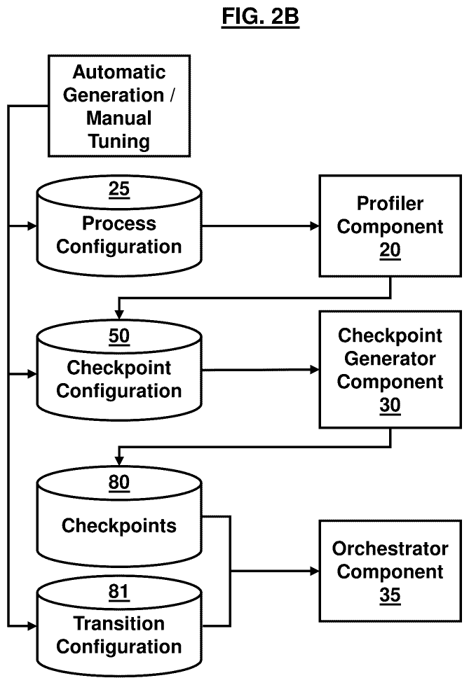

Referring now to the drawings, and more particularly to FIGS. 2A through 8, where similar reference characters denote corresponding features consistently throughout the figures, there are shown preferred embodiments. In the drawings, the size and relative sizes of components, layers, and regions, etc. may be exaggerated for clarity.

The system 10 described herein may comprise various controllers, switches, processors, and circuits, which may be embodied as hardware-enabled modules and may be a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that include electronic circuits process computer logic instructions capable of providing digital and/or analog signals for performing various functions as described herein.

The various functions can further be embodied and physically saved as any of data structures, data paths, data objects, data object models, object files, database components. For example, the data objects could include a digital packet of structured data. Example data structures may include any of an array, tuple, map, union, variant, set, graph, tree, node, and an object, which may be stored and retrieved by computer memory and may be managed by processors, compilers, and other computer hardware components. The data paths can be part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and can be a variable, a data structure, or a function. Some examples of the modules include relational databases (e.g., such as Oracle® relational databases), and the data objects can be a table or column, for example. Other examples include specialized objects, distributed objects, object-oriented programming objects, and semantic web objects. The data object models can be an application programming interface for creating HyperText Markup Language (HTML) and Extensible Markup Language (XML) electronic documents. The models can be any of a tree, graph, container, list, map, queue, set, stack, and variations thereof, according to some examples. The data object files can be created by compilers and assemblers and contain generated binary code and data for a source file. The database components can include any of tables, indexes, views, stored procedures, and triggers.

Various examples described herein may include both hardware and software elements. The examples that are implemented in software may include firmware, resident software, microcode, etc. Other examples may include a computer program product configured to include a pre-configured set of instructions, which when performed, may result in actions as stated in conjunction with the methods described above. In an example, the preconfigured set of instructions may be stored on a tangible non-transitory computer readable medium or a program storage device containing software code.

FIG. 2A illustrates a networked computer system 10 for automated substitution process 40 with reserved connection capabilities in a network 15. The networked computer system 10 comprises a profiler component 20 that collects information about a candidate process 25 and generates a configuration file 50; a checkpoint generator component 30 that instantiates, suspends, and stores information for execution of the candidate process 25 and creates a checkpoint 80 (also referred to herein as a “checkpoint information process”) based on the configuration file 50; and an orchestrator component 35 that receives the checkpoint 80 and a transition configuration 81 to manages and enacts a substitution process 40 for the candidate process 25 for counteracting unauthorized use of predetermined data 29 in the network 15 while maintaining all network connections during execution of the substitution process 40. For example, the predetermined data 29 may represent the real data assets, etc. in the network 15.

The system 10 is a sophisticated mechanism for switching between different security honeypots in a network 15. The switchover mechanism can switch between different security honeypots on a local device. This switchover happens on-the-fly. In other words, the switchover occurs without interrupting the ongoing processes, and it preserves data related to network sessions. The mechanism comprises a profiler component 20, a checkpoint component 30, and a honeypot orchestrator component 35. These components work together to collect information about running processes, create checkpoints, and manage the transition between different honeypots. The profiler component 20 gathers information about a process, especially focusing on network-related details like listening ports and addresses. The profiler component 20 may use a tool called strace to log system calls and interacts with the process to gather network information. With the checkpoint component 30, checkpoints 80 may be created using a tool called CRIU®, for example. Checkpoints 80 can be time-based or automatic, triggered by specific events like a TCP handshake or a certain packet payload, etc. In an example, automatic checkpoints involve a custom C program that overrides system call functions. The honeypot orchestrator component 35 is responsible for switching between different honeypot processes seamlessly. This component 35 uses a configuration file 50 to determine when and how switchovers happen, either based on time or specific system calls. Active connections are preserved during the switch. Configuration details may be stored in a JSON format, for example, making it easy for both automation and manual adjustments. The configuration includes information about processes, checkpoints, and transitions between honeypots.

The networked computer system 10 facilitates an automated substitution process 40 with reserved connection capabilities within a network 15. This system comprises a profiler component 20, a checkpoint generator component 30, and an orchestrator component 35. The profiler component 20 is responsible for gathering information about a candidate process 25 and generating a configuration file 50. The checkpoint generator component 30 takes this configuration file 50, instantiates, and suspends the candidate process 25, creating a checkpoint 80. This checkpoint 80 serves as a record of the candidate process's state and execution information. The orchestrator component 35, equipped with the checkpoint 80 and a transition configuration 81, manages and enacts a substitution process 40 for the candidate process 25. This substitution process 40 is designed to counteract unauthorized use of predetermined data 29 within the network 15. The predetermined data 29 could represent critical assets in the network 15. The substitution process 40 is executed while maintaining all network connections intact, ensuring continuity in communication. The networked computer system 10 provides an automated and seamless mechanism for substituting a candidate process 25 with reserved connection capabilities, contributing to enhanced security and protection of predetermined data 29 within the network 15.

FIG. 2B, with reference to FIG. 2A, illustrates a process flow for operating the system 10. In addition to the components 20, 30, 35, the system 10 comprises a plurality of data stores (shown in FIG. 2B as process configuration (i.e., candidate process) 25, checkpoint configuration (i.e., configuration file) 50, checkpoints 80, and transition configuration 81). The candidate process 25, checkpoint configuration file 50, and transition configuration 81 can be, for example, automatically generated and manually tuned. The profiler component 20 collects information about the candidate process 25 and then generates the configuration file 50 that includes network and file descriptor information. Checkpoints 80 are created by suspending a process and storing all data that is required to resume it at a later time. The checkpoint generator component 35 creates these checkpoints 80 at certain points in a process' execution based on the checkpoint configuration file 50. The orchestrator component 35 reads the transition configuration 81 and handles the instantiation and transition of honeypots across various levels of fidelity when specified conditions are met (either based on time or system calls).

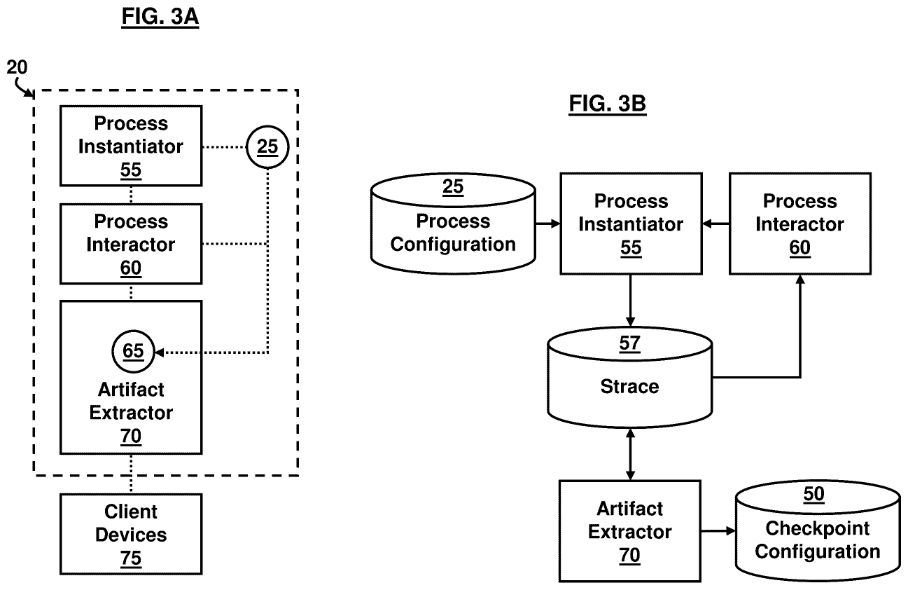

As shown in FIG. 3A, with reference to FIG. 2A and 2B, the profiler component 20 may comprise a process instantiator 55 that executes the candidate process 25; a process interactor 60 that establishes a simple network connection with the candidate process 25 to reveal specific file descriptors 65 associated with the established network connection or connections; and an artifact extractor 70 that stores the specific file descriptors 65 associated with the established network connection or connections to client devices 75 so that subsequent phases are able to pinpoint particular information required for a transition to the substitution process 40. The process interactor 60 logs system calls 45 executed by the candidate process 25. The profiler component 20 extracts key information about the candidate process 25 by executing the candidate process 25 and analyzing system calls 45 associated with file and network actions during execution. The system calls 45 include network socket system calls 45x which are parsed to obtain information about listening ports and listening interface addresses.

The profiler component 20 comprises the following modules: the process instantiator 55, the process interactor 60, and the artifact extractor 70. The process instantiator 55 is responsible for executing the candidate process 25, initiating its runtime. Subsequently, the process interactor 60 establishes a straightforward network connection with the candidate process 25, enabling the revelation of specific file descriptors 65 associated with the established network connections. Simultaneously, the process interactor 60 logs the system calls 45 executed by the candidate process 25. This logging mechanism captures critical information about the candidate process 25 execution behavior. The artifact extractor 70 plays a pivotal role in storing these specific file descriptors 65, associated with the network connection, and forwards this information to client devices 75. This stored data becomes instrumental in subsequent phases, offering precise details essential for transitioning to the substitution process 40.

The profiler component 20 functions by executing the candidate process 25 and meticulously analyzing the system calls 45 associated with file and network actions throughout its execution. The system calls 45 include specialized network socket system calls 45x, which are parsed to extract crucial details about listening ports and listening interface addresses. This allows the profiler component 20 to build a comprehensive understanding of the candidate process 25 behavior, specifically in the context of network interactions. The information gathered serves as a foundation for subsequent phases within the system 10, facilitating a seamless transition to the substitution process 40 based on the intricacies of the candidate process 25 network-related activities.

As further shown in the process flow diagram of FIG. 3B, with reference to FIGS. 2A through 3A, the profiler component 20 reads the candidate process 25 for information about how the candidate process 25 should be executed, including any required input arguments, paths, and data files. In an example, the candidate process 25 may be instantiated by the process instantiator 55 with the Linux® strace utility 57 to log all system calls 45 executed by the candidate process 25 including the network socket system calls 45x, which are parsed to obtain information about listening ports and listening interface addresses. The process instantiator 55 then re-executes the program, but this time, the process interactor 60 uses the obtained network information to establish a simple network connection with the candidate process 25 using, for example, the Netcat® utility. This interaction reveals the specific file descriptors 65 associated with the established network connection or connections to client devices 75. The artifact extractor 70 stores this network information a checkpoint configuration 50 so that the subsequent phases are able to pinpoint particular information required for a transition 81; including the file descriptors associated 65 with connections to client devices 75.

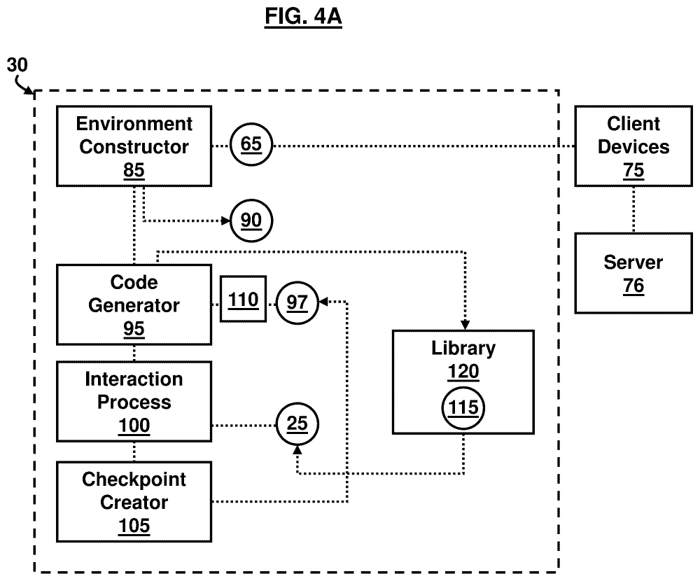

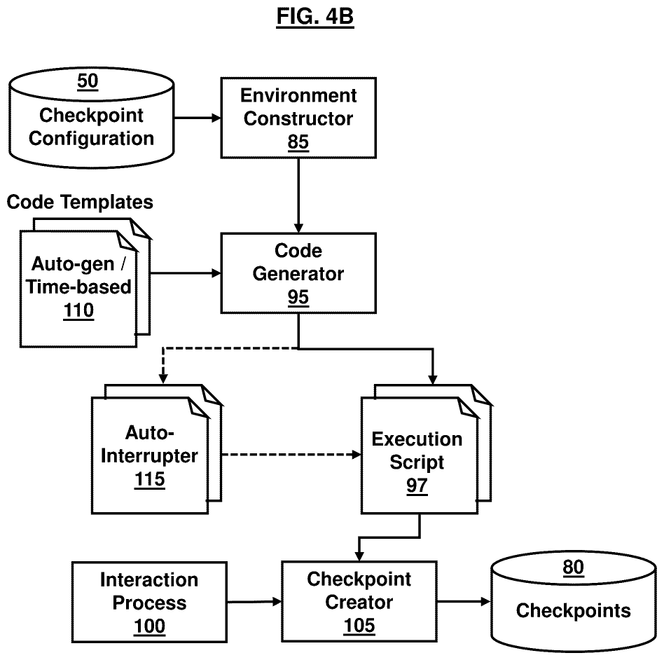

The checkpoint generator component 30 creates the checkpoint (i.e., checkpoint information process) 80 by suspending the candidate process 25 and storing all data that is required to resume the candidate process 25 at a later time. As shown in FIG. 4A, with reference to FIGS. 2A through 3B, the checkpoint generator component 30 may comprise an environment constructor 85 that reads file descriptors 65 associated with an established network connection or connections to a client device 75 complied by the profiler component 20 and generates at least one directory 90 that will be used to store time-based and automatic checkpoints for the candidate process 25; a code generator 95 that creates an execution script 97 for the candidate process 25; an interaction process 100 that connects to the candidate process 25 to checkpoint in a connected state; and a checkpoint creator 105 that runs the execution script 97 for the candidate process 25. The code generator 95 uses a template engine 110 such as jinja2 templates, for example, to create the execution script 97. The code generator 95 creates an auto-interrupter program 115 that overrides system call functions, which is compiled into a library 120 that is pre-loaded into a target candidate process 25.

In an example, the process checkpoints 80 may be created using Checkpoint Restore in Userspace (CRIU®) software. The system 10 can use the CRIU® software along with additional mechanisms to provide users with the ability to create both time-based and automatic checkpoints 80. As further shown in the process flow diagram of FIG. 4B, with reference to FIGS. 2A through 4A, in the checkpoint generator component 20, the environment constructor 85 begins by reading the checkpoint configuration 50 and generates directories that will be used to store time-based and automatic checkpoints 80. For time-based checkpoints, the execution script 97 contains the logic that calls the CRIU® command-line interface (CLI) utility after a given time. The target's process identifier (ID) is also provided as an input. These checkpoints 80 are not based on observed system call invocations. As an example usage, after a web application has been running for an extended period, this can be used to portray a longstanding server 76.

For automated checkpoints, in addition to the execution script 97, the code generator 95 creates an auto-interrupter 115, which may be a custom C program that overrides system call functions, for example. This program is compiled into the library 120 that is pre-loaded into the target candidate process 25. Automatic checkpoints are used when a process switchover is to occur. Some examples include, immediately after a TCP handshake, when a particular packet payload is encountered, a connection request occurs from a specific IP address range. Automatic checkpoints are taken at specific points in the process' execution, based on systems calls. This behavior is accomplished using the CRIU® remote procedure call (RPC) capability. For example, if the checkpoint configuration 50, which is generated by the profiler component 20, indicates that the process should checkpoint when the accept function is called, which typically happens immediately after a TCP 3-way handshake is completed, with a file descriptor of three, the generated preload library 120 includes code to override accept with additional logic to checkpoint when the file descriptor 65 is equal to three. Afterward, the overridden function will call the original, which occurs whenever the checkpoint 80 is resumed.

The checkpoint creator 105 runs the execution script 97 and the interaction process 100 connects to the candidate process 25 in order to checkpoint 80 in a connected state. The raw checkpoint data is stored in the directory 90 created by the environment constructor 85. Additionally, a CRIU® Image Tool (CRIT) utility may be used to also store a plain text version of checkpoint information, according to an example.

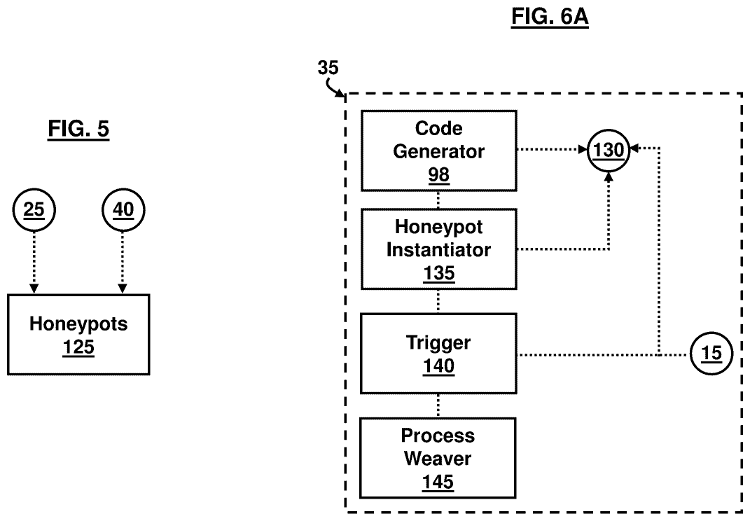

As shown in FIG. 5, with reference to FIGS. 2A through 4B, the candidate process 25 and the substitution process 40 for the candidate process 25 may comprise honeypots 125. In an example, the orchestrator component 35 may be a honeypot component 125. The honeypots 125 may comprise decoy devices or services or a combination thereof operating on the network 15 that are used to lure attackers away from the predetermined data 29. The orchestrator component 35 handles an instantiation and transition of the substitution process 40 for the candidate process 25 when specified conditions are met based on time or system calls 45. Moreover, the orchestrator component 35 interweaves data across processes that are needed to preserve network connections.

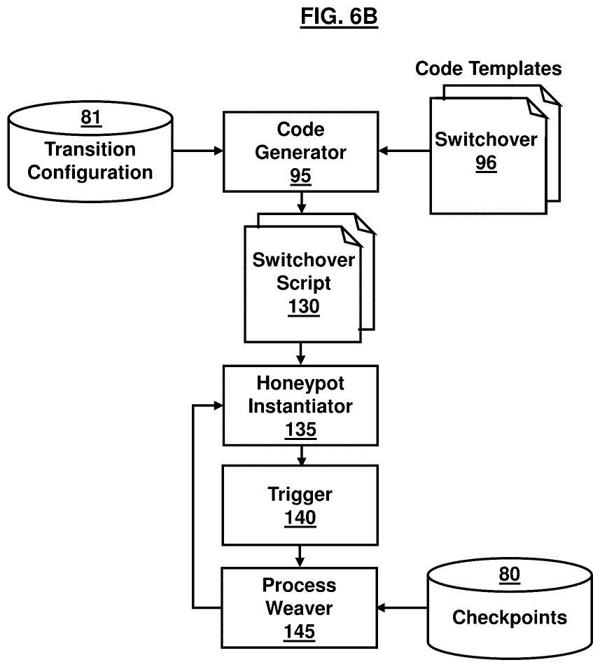

As shown in FIG. 6A, with reference to FIGS. 2A through 5, the orchestrator component 35 may comprise a code generator 98 that creates a switchover script 130 for executing the substitution process 40 for the candidate process 25; a honeypot instantiator 135 that executes the switchover script 130; a trigger 140 that analyzes the executed switchover script 130 and determines and stores information about a current network state of the network 15; and a process weaver 145 that retrieves information regarding at least one previous target and updates a socket to match that of a current process.

The purpose of the orchestrator component 35 is to instantiate and to seamlessly switch between different honeypot processes. As shown in the process flow diagram of FIG. 6B, with reference to FIGS. 2A through 6A, all processes involved in a switchover have a checkpoint configuration. This will be used to determine when and how switchovers take place: time-based vs. automated and the target honeypot checkpoint, respectively. Additionally, target honeypots (i.e., those that will be switched to) have a pre-recorded checkpoint. All of this information is read from the transition configuration 81. The code generator 95 uses a template engine 96, such as a jinja2 template, to create the switchover script 130, which is executed by the honeypot instantiator 135. When the condition for switching is met, the trigger 140 checkpoints the current process. Information about the current network state is stored and converted into an editable format using CRIT, for example. The process weaver 145 retrieves the target honeypots previously stored checkpoint and updates the socket to match that of the current process.

More specifically according to an example, during these steps, SocketWeaver, which is a Python program that parses the decoded (e.g., from Protobuf® binary to JavaScript® Object Notation (JSON) format) files.img information. The script 130 finds the properties associated with the network sockets, indicated by the value for the INETSK key. Afterward, those that are in an established state, indicated by the value of the isk-state key, are identified. The identifiers for these, specifically, the values for the id, ino, src_port, src address, src_port, and dst_port, are extracted. These are used to overwrite the associated values in the target honeypot checkpoint data. Finally, the tcpstream.img files associated with the active connection or connections, whose naming is based on the ino, are directly copied into the directory that holds the target honeypot checkpoint data.

Afterward, the target honeypot data is re-encoded into its binary form and the honeypot instantiator 135 restores the target honeypot. This mechanism preserves active connections, and, to the connecting agent (e.g., a scanner), there are no noticeable effects in content and interaction aside from small delays in some cases, depending on the performance of the device running the switching mechanism.

The configuration specifications may be stored in the JSON format, which is human-readable and intrinsic to Python. This facilitates automation and allows for manual fine-tuning. Table I describes the key value pairs that make up the candidate process. These values are entered manually by the user and the resulting file is used by the profiler component 20.

TABLE I
Candidate process Elements

| Element | Description |
|---|---|
| ID | Unique identifier to keep track of processes, configurations, and |
| | associated data |
| aux-setup | Additional commands that need to be executed before the process |
| run-cmd | Binary or script that instantiates the process |
| criu-bin-path | Location of the CRIU ® binary that will be used when invoking the |
| | CLI and RPC |
| criu-service- | Location where the CRIU ® should execute as a service to listen for RPC |
| run-path | commands |

As indicated in Table I, the configuration file 50 may be defined by a unique identifier element to keep track of processes, configurations, and associated data; a commands element to be executed before the processes; a binary or script element to instantiate the processes; a first path element to identify a location of a checkpoint/restore in userspace (CRIU®) binary; and a second path element to identify where the CRIU® binary is to be executed.

The checkpoint configuration 50 specification is described in Table II. This file is generated automatically by the profiler component 20. The ID, proc-port, and fd-trigger values are extracted from the process execution. All other fields are set as defaults. The items marked with a single star are specific to time-based checkpoints while those marked with a double star are specific to automatic checkpoints.

TABLE II
Checkpoint Configuration Elements

| Element | Description |
|---|---|
| ID | Unique identifier that matches that specified in the candidate process |
| proc-port | Port that the process listens on for network communication |
| clear-dir | Indicates whether the checkpoint data should be overwritten if the |
| | target directory is not empty |
| method | Either time-based or automatic checkpoint type |
| graceful-discon | Specifies whether the system should attempt to gracefully close the |
| | connection after a checkpoint - the alternative is to leave the |
| | connection open |
| store-path | Location where checkpoint data will be stored |
| template | Location of the template that will be used to generate the script for |
| | creating the check- point |
| converter-path | Location of the program to convert specific checkpoint files from |
| | Protobuf ® to JSON |
| weaver-path | Location of the program that transfers network socket information |
| | across checkpoints |
| out-script | Location where the auto-generated checkpoint Execution Script will |
| | reside |
| *pid-ID | Command that will be executed to isolate and extract the ID of the |
| | running process |
| *delay | Duration that the system will wait before the checkpoint is taken |
| **lib-template-path | Location of the jinja template that will be used to generate the C code |
| | for the pre-load library |
| **syscall-trigger | System calls that will be overridden and that will potentially |
| | checkpoint the process, depending on whether the file descriptor |
| | matches |
| **fd-trigger | File descriptors that will be compared within the system call functions |
| | to determine whether a process should be check- pointed |
| **force-compile- | Whether to compile the generated library if the binary already exists |
| pre-load | |
| **checkpoint-on- | In the case of multiple system call and file descriptor matches, this |
| encounter | specifies on what iterations the checkpoints should be taken |
| **lib-path-store | Location where the pre-load library source file will be stored |

Accordingly, as indicated in Table II, the checkpoint 80 may be defined by: a unique identifier element that matches a unique identifier specified in the candidate process 25; a port element that the checkpoint (i.e., checkpoint information process) 80 utilizes for network communication; a directive element that indicates whether checkpoint data should be overwritten if a target directory is not empty; and a method element that identifies whether a time-based or automatic checkpoint type occurs. The checkpoint 80 may further be defined by a connection element that specifies whether a network connection should gracefully close after the checkpoint 80; a store element that identifies a location where checkpoint data will be stored; a template element that identifies a location of a template that will be used to generate a script for creating the checkpoint 80; a converter element that identifies a location of a software program to convert specific checkpoint files from one data interchange format to another; a weaver element that identifies a location of the software program that transfers network socket information across checkpoints; a script element that identifies a location where an auto-generated checkpoint execution script will reside; a command element that isolates and extracts an identification of a running process; and a delay element that identifies a duration before the checkpoint 80 is selected. The checkpoint 80 may further be defined by a template element that identifies a location of a template engine that will be used to generate the code for a pre-load library source file; a first trigger element that identifies system calls 45 that will be overridden and that will potentially checkpoint the process, depending on whether a file descriptor matches; a second trigger element that identifies file descriptors that will be compared within system call functions to determine whether the process should be checkpointed; a compile element that determines whether to compile a generated library if a binary already exists; a checkpoint element that specifies, in the case of multiple system call and file descriptor matches, which iterations the checkpoints should be taken; and a library element that identifies a location where the pre-load library source file will be stored.

The transition configuration 81 is mostly a union of the process 25 and checkpoint 50 configurations. The following describes some specific time-based and automatic configurations for the honeypot processes that were used for testing and evaluation. The first process is a simple listener that helps with many of the mechanics of the system 10. The other five processes were selected by first analyzing the scanning profile for the Nmap® tool. The Nmap® tool comes prebuilt with a file that contains the statistics associated with the most commonly scanned ports. According to these statistics, based on Nmap® version 7.92, ports 80, 23, 443, 21, and 22, which are associated with HTTP, telnet, HTTPS, file transfer protocol (FTP), and secure shell protocol (SSH®) respectively, are ranked as the top five.

The Netcat® tool is a multi-purpose cross-platform network utility. It has two uses as a honeypot process. First, it serves as a low fidelity and low-resource process that can be suspended and then transitioned to a higher-fidelity honeypot. The Netcat® utility can run on custom ports as specified by the user (using the-p option). Second, the Netcat® utility can also be used as a target honeypot to decrease fidelity; e.g., if there is a lack of connection or communication activity, this can used to regain resources.

A time-based configuration works well for a Netcat® listener because of its simple, echo server, behavior. The configurations (excluding ID, path entries, and many default values) for the listener are shown in Listing 1.

Listing 1—Config Snippets: Low-Interaction Netcat® Honeypot

```
“process-configuration”: {
  “run-cmd” : “ncscript.sh”,
}
“checkpoint-configuration”: {
  “proc-port”: [“80”],
    “method”: “time-based”,
    “pid-ID” : [“′ps -ef |”,
        “grep ‘ncscript.sh’ |”,
        “head −1 |”,
        “awk {‘print \$2’}′”]
    “delay”: “5”,
      }
```

For its candidate process, the run-cmd is a reference to a script, called ncscript.sh, that runs the Netcat® utility in a new namespace, in listen mode (−l flag) on port 80 (specified along with the −p flag). A chain of commands is used to identify the process ID because a simple process listing will contain multiple results. The backend system components, and more specifically, the jinja-generated code, reads the pid from the standard output and uses it, together with the CRIU® CLI, to checkpoint the process.

Related to its checkpoint, the directories will be cleared on every run. The profiler component 20 detects that this instance of Netcat® runs on port 80 and the checkpoint is specified to be time-based. The graceful-discon is set to true, indicating that during checkpoint creation, the suspended process will be resumed and then shutdown gracefully to ensure that there are no hanging connections. This does not remove the checkpoint data, however.

A time-based checkpoint configuration, using Nginx® as the executive, was used for both HTTP (port 80), and HTTPS (port 443). With this web server, when a client device 75 connects (a TCP handshake is completed) to the network 15, the server awaits a request from the client 15. Alternatively, an automatic checkpoint will also work, however, using a time-based configuration also provides the ability to, as mentioned previously, use a longstanding web server as a target honeypot.

The setup script, called https_setup.sh, creates a private key and a certificate and modifying the mysite.template file to use tls. The configuration for HTTP is nearly identical except without the auxiliary setup script. It also only listens on port 80.

Finding a standalone telnet service that runs on modern Linux® systems is a non-trivial task. The internet service daemon (inetd) is a broker that listens for connections on multiple ports and then forward requests to backend listeners. One of the available listeners is telnetd. In this implementation of telnet, when a client device 75 connects, the server immediately sends back data (which is the login banner). The configuration for telnet uses an automatic checkpoint type, to occur immediately after the TCP handshake and before any data is sent to a client device 75.

The run command is simply the inetd binary. Telnet listens on port 23 and this particular version calls accept and uses a file descriptor of 7. Finally, configuration specifies that a checkpoint should only occur the first time that the accept function with this file descriptor. This is useful when testing against the Nmap® network scanner with service detection as it connects and disconnects to the service several times during its banner grabbing process.

The inetd service is also capable of hosting an ftp server, however, the pure-ftpd standalone version was used to broaden the testing. The configurations for pure-ftpd are very similar to that of telnet. The FTP server may be run in IPv4 mode using the −4 flag. For example, the port used is 21 and the file descriptor identified by the profiler component 20 is 4. As with Telnet, the checkpoint is taken only on the first time the system call and file descriptor are encountered.

The SSH® server may be instantiated using OpenSSH_8.9p1 in standalone (non-daemon) mode. Additional artifacts should be created before the server can run this way. Parts of the configurations for SSH® are shown in Listing 2.

Listing 2—Config Snippets: SSH® High-Interaction Honeypot

```
“process-configuration”: {
  “aux-setup”: [“mkdir /run/sshd;”,
          “mkdir -p keys;”,
          “ssh-keygen”,
          “-q -t rsa -N”,
          “\”\” -f”,
          “keys/ssh_host_rsa_key”],
  “run-cmd” : [“/usr/sbin/sshd “,
        “-h keys/ssh_host_rsa_key”,
        “-D”],
}
  “checkpoint-configuration”: {
    “proc-port”: [“22”],
    “method”: “auto”,
      “systemcall-trigger” : “accept”
      “fd-trigger”: [“3”],
}
```

The auxiliary setup script is used to create a directory to hold the process ID and to create public and private encryption keys. The server is executed using the −D flag to specify standalone mode and the keys are specified along with the −H option. The process listens on port 22, uses the accept function for incoming connections, and uses a file descriptor of 3. These configurations were used to evaluate timing associated with the switchover mechanism.

Experimentally, the Nmap® scanning tool was used to scan the top five most commonly scanned TCP ports using the configurations described above. To ensure that the test was run in a constrained setting, the switchover mechanism was installed on a virtual machine with 2 GB of RAM and 2 CPUs. The operating system used is Kali Linux 2021.4a running kernel version 5.14 and CRIU® version 3.16.1.

To introduce minimal network latency, the host machine scanned the virtual machine through a VirtualBox® host-only adapter. In all tests, the simple Netcat® listener is the initial honeypot and the target honeypots are the full service binaries. Switching occurs immediately after a TCP 3-way handshake.

Timing reports from Nmap® service version detection scans (using the −sV flag) are shown in Table III.

TABLE III
Nmap ® Scan Report Times

| | | |
|---|---|---|
| Service/Port | Time | Time (with system 10) |

| | | | | |
|---|---|---|---|---|
| http (80) | 24.2 | s | 24.41 | s |
| telnet (23) | 64.35 | s | 64.4 | s |
| ssl/https (443) | 30.37 | s | 30.47 | s |
| ftp (21) | 18.26 | s | 20.39 | s |
| ssh ® (22) | 18.3 | s | 20.48 | s |

In all cases, the Nmap® tool reported the correct, high-interaction honeypot, service; with a maximum of 2 s delay with FTP and SSH® services. The Nmap® tool was also tested using its SYN scan feature, which does not establish a complete 3-way handshake during its scan, which in turn would not cause the switching to occur.

The Nmap® tool identified all of the correct ports without any observable differences or delays. This latter test can be used to preserve system resources, which is especially important on small-scale devices, such as Internet of Things (IoT). This allows several low-interaction honeypots to run at once as they will only switch to a high-interaction service when a scanner chooses to be less stealthy by performing deeper probes.

The system 10 may be embodied as an electronic device according to an example. For example, the system 10 as embodied as an electronic device may comprise any suitable type of communication device capable of transceiving data. In other examples, system 10 as embodied as an electronic device may comprise a computer, all-in-one (AIO) device, laptop, notebook computer, tablet device, mobile phone, smartphone, electronic book reader, appliance, gaming system, electronic toy, web-based server, local area network server, cloud-based server, etc., among other types of electronic devices that communicate with another device wirelessly.

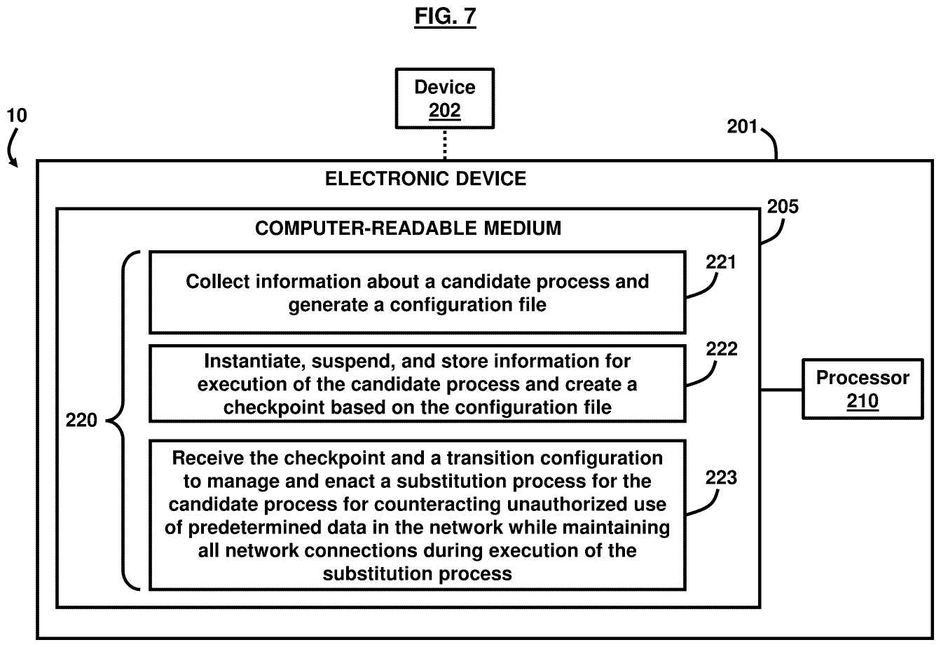

FIG. 7, with reference to FIGS. 2 through 6B, illustrates another example of the system 10 for automated substitution process 40 with reserved connection capabilities in a network 15. The system 10 comprises an electronic device 201 containing a computer-readable storage medium 205, and a remote communication device 202 communicatively linked to the electronic device 201. In the example of FIG. 7, the electronic device 201 includes a processor 45 and the computer-readable storage medium 205.

Processor 45 may include a central processing unit, microprocessors, hardware engines, and/or other hardware devices suitable for retrieval and execution of instructions stored in a computer-readable storage medium 205. Processor 45 may fetch, decode, and execute computer-executable instructions 220 to enable execution of locally-hosted or remotely-hosted applications for controlling action of the electronic device 201. The remotely-hosted applications may be accessible on remotely-located devices; for example, the remote communication device 202. For example, the remote communication device 202 may be a laptop computer, tablet device, smartphone, or notebook computer. As an alternative or in addition to retrieving and executing instructions, processor 45 may include electronic circuits including a number of electronic components for performing the functionality of the computer-executable instructions 220.

In some other examples, the processor 45 described herein and/or illustrated in the figures may be embodied as hardware-enabled modules and may be configured as a plurality of overlapping or independent electronic circuits, devices, and discrete elements packaged onto a circuit board to provide data and signal processing functionality within a computer. An example might be a RF switch, antenna tuner, comparator, inverter, or flip-flop, which could include a plurality of transistors and other supporting devices and circuit elements. The modules that are configured with electronic circuits process and/or execute computer logic instructions capable of providing digital and/or analog signals for performing various functions as described herein including controlling the operations of the system 10 and associated components. In some examples, the processor 45 may comprise a central processing unit (CPU) of the system 10. In other examples the processor 45 may be a discrete component independent of other processing components in the system 10. In other examples, the processor 45 may be a semiconductor-based microprocessor, microcontroller, field-programmable gate array (FPGA), hardware engine, hardware pipeline, and/or other hardware-enabled device suitable for receiving, processing, operating, and performing various functions for the system 10. The processor 45 may be provided in the system 10, coupled to the system 10, or communicatively linked to the system 10 from a remote networked location, according to various examples.

The computer-readable storage medium 205 may be any electronic, magnetic, optical, or other physical storage device that stores executable instructions. Thus, the computer-readable storage medium 205 may be, for example, Random Access Memory, an Electrically-Erasable Programmable Read-Only Memory, volatile memory, non-volatile memory, flash memory, a storage drive (e.g., a hard drive), a solid-state drive, optical drive, any type of storage disc (e.g., a compact disc, a DVD, etc.), and the like, or a combination thereof. In one example, the computer-readable storage medium 205 may include a non-transitory computer-readable storage medium 205. The computer-readable storage medium 205 may be encoded with executable instructions for enabling execution of remotely-hosted applications accessed on the remote communication device 202. In an example, the processor 45 of the electronic device 201 executes the computer-executable instructions 220 that when executed cause the electronic device 201 to perform computer-executable instructions 221-223.

As shown in FIG. 7, the computer-readable medium 205 is configured for storing instructions 220 to collect information, in block 221, about a candidate process 25 and generate a configuration file 50. The instructions 220 further instantiate, suspend, and store information, in block 222, for execution of the candidate process 25 and create a checkpoint 80 (i.e., a checkpoint information process) based on the configuration file 50. The instructions 220 further receive the checkpoint 80 and a transition configuration 81 to manage and enact a substitution process 40, in block 223, for the candidate process 25 for counteracting unauthorized use of predetermined data 29 in the network 15 while maintaining all network connections during execution of the substitution process 40.

The embodiments herein may also include tangible and/or non-transitory computer-readable storage media for carrying or having computer-executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions 220 include, for example, instructions and data which cause a special purpose computer or special purpose processing device to perform a certain function or group of functions. Computer-executable instructions 220 also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions 220, associated data structures, and program modules represent examples of the program code means for executing steps of the methods disclosed herein. The particular sequence of such executable instructions 220 or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network. If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, including advanced computer products having a display, a keyboard or other input device, and a central processor.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

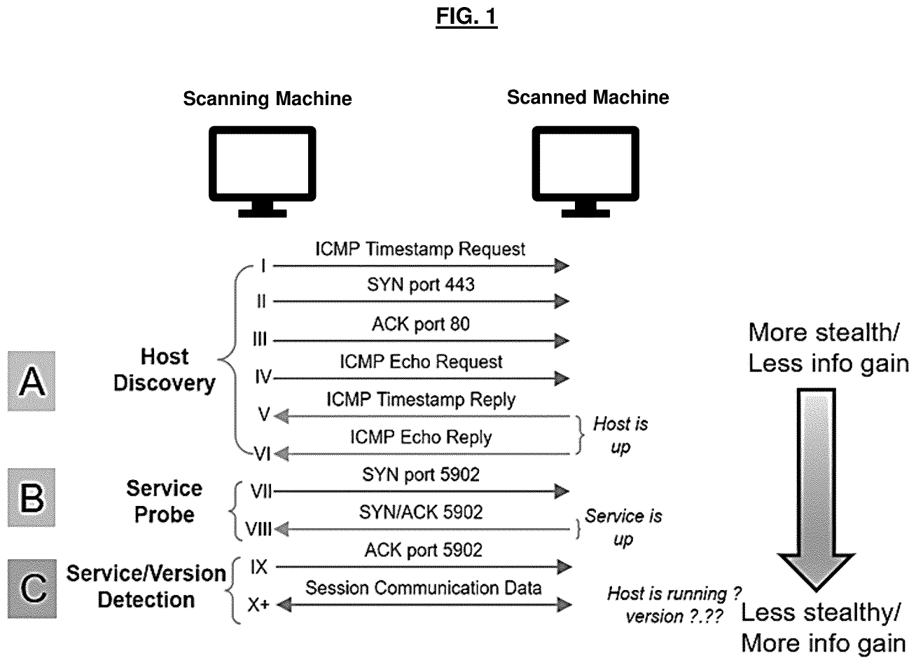

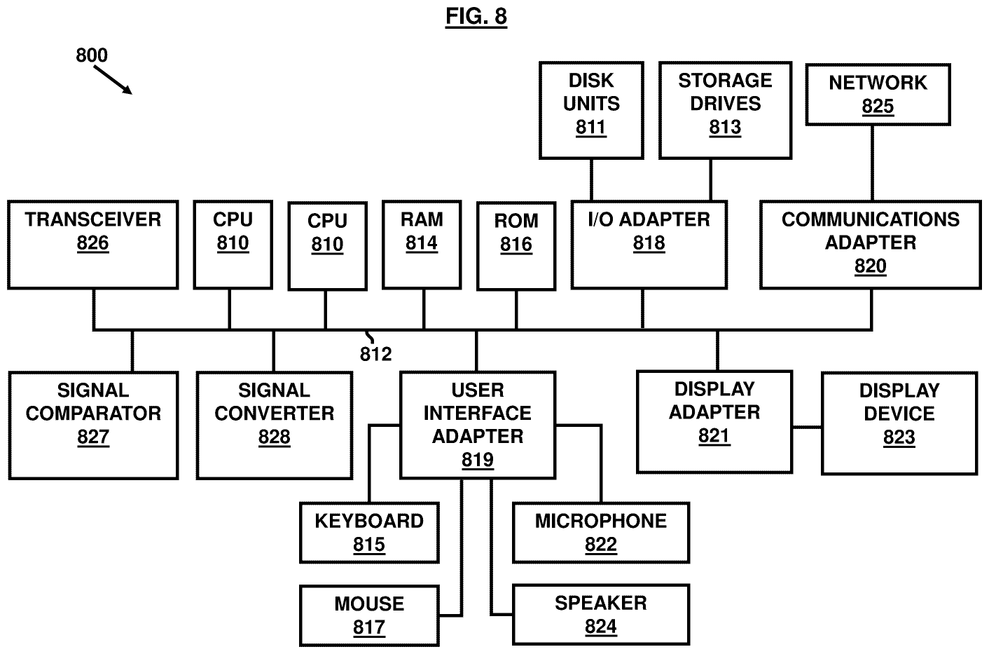

A representative hardware environment for practicing the embodiments herein is depicted in FIG. 8, with reference to FIGS. 1 through 7B. This schematic drawing illustrates a hardware configuration of an information handling/computer system 800 in accordance with the embodiments herein. The system 800 comprises at least one processor or central processing unit (CPU) 810. The CPUs 810 are interconnected via system bus 812 to various devices such as a random access memory (RAM) 814, read-only memory (ROM) 816, and an input/output (I/O) adapter 818. The I/O adapter 818 can connect to peripheral devices, such as disk units 811 and tape drives 813, or other program storage devices that are readable by the system. The system 800 can read the inventive instructions 220 on the program storage devices and follow these instructions to execute the methodology of the embodiments herein. The system 800 further includes a user interface adapter 819 that connects a keyboard 815, mouse 817, speaker 824, microphone 822, and/or other user interface devices such as a touch screen device (not shown) to the bus 812 to gather user input. Additionally, a communication adapter 820 connects the bus 812 to a data processing network, and a display adapter 821 connects the bus 812 to a display device 823 which may be embodied as an output device such as a monitor, printer, or transmitter, for example. Further, a transceiver 826, a signal comparator 827, and a signal converter 828 may be connected with the bus 812 for processing, transmission, receipt, comparison, and conversion of electric or electronic signals.

The embodiments herein provide a multi-fidelity honeypot system 10 that runs on a local device. The system 10 is capable of suspending and switching to different honeypot processes, on-the-fly, while carrying over their active network connections. An experimental evaluation of the system 10 on a constrained virtual machine indicates that the switchover behavior is seamless and delays are negligible: the behavior and reporting of the Nmap* scanning tool, as well as legitimate client applications, does not change when interacting with the system 10.

The system 10 substitutes one or more running network processes 25 with suspended processes 40 while maintaining all network connections. Both the running process 25 and suspended process 40 can be the same process or completely different processes in any state of execution. Network connections are not interrupted during or after the switchover. The system 10 may be configured for automation, and it can be fine-tuned through several configuration files 50. The system utilizes the profiler component 20 to extract key information about the candidate processes 25 by running them and analyzing system calls associated with file and network actions. This data is passed to the checkpoint generator component 30, which instantiates, suspends, and stores all information required for the process 25 to resume at a later time (called checkpoints 80). Checkpoints 80 can be taken at different states during execution. The orchestrator component 35 manages and enacts the process substitutions. During switchover, the orchestrator component 35 also interweaves data across processes that are needed to preserve the network connections.

The embodiments herein allow for processes, even those with different resource needs and fidelity, to be substituted dynamically. Network connections are not severed as with traditional connection migration techniques. Additionally, there is no need for additional networked devices, as is the case with conventional network carryover techniques. Instead, with the system 10, the network connection information is carried across processes such that a connected or connecting entity will not be able to observe the switching behavior. Finally, the embodiments herein are automated, but can also be manual fine-tuned given the configuration infused pipeline architecture.

The system 10 enables defenders to configure and deploy honeypots 125 that adapt on-the-fly. Adaptable elements include process fidelity, the service hosted, the state of the service, and the load it introduced on a system, among many other possibilities. This results in cost and resource savings as well as more efficient and more effective defenses. With this system 10, even small-scale and otherwise constrained devices such as Internet of Things devices; e.g., smart phones, smart TVs, etc., robotics, embedded devices, and autonomous systems, can host honeypots due to the dynamic capabilities provided by the system 10. These devices can host a multitude of low-interaction, low-resource honeypots and switch to high interaction, higher-resource honeypots; e.g., when an adversary is observed to show interest in a specific type of service or asset.

Networking infrastructure technologies may benefit from the techniques provided by the embodiments herein. Performance is critical in network components, such as routers, switches, controllers, and others. Thus, these devices usually include only the code and hardware that is necessary for their intended behavior. The tunability of the system 10 may open the possibility for these such devices to host dynamic defense technologies such as adaptable honeypots. Finally, this system 10 is not limited to the security domain; it can also be used to improve performance of systems; allowing them to host only required assets and semi-services; and then switch to required level of fidelity based on client needs. For example, a simple web server may not need all components of its functionality, depending on client interaction. This can bring resource savings by only hosting components that are required and switching between them in an on-demand fashion.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A networked computer system for automated substitution process with reserved connection capabilities, the networked computer system comprising:
a profiler component that collects information about a candidate process and generates a configuration file;
a checkpoint generator component that instantiates, suspends, and stores information for execution of the candidate process and creates a checkpoint based on the configuration file; and
an orchestrator component that receives the checkpoint and a transition configuration to manage and enact a substitution process for the candidate process for counteracting unauthorized use of predetermined data in the network while maintaining all network connections during execution of the substitution process.

2. The networked computer system of claim 1, wherein the profiler component extracts key information about the candidate process by executing the candidate process and analyzing system calls associated with file and network actions during execution.

3. The networked computer system of claim 1, wherein the profiler component generates a configuration file that includes network and file descriptor information.

4. The networked computer system of claim 3, wherein the configuration file is defined by:
a unique identifier element to keep track of processes, configurations, and associated data;
a commands element to be executed before the processes;
a binary or script element to instantiate the processes;
a first path element to identify a location of a checkpoint/restore in userspace (CRIU®) binary; and
a second path element to identify where the CRIU® binary is to be executed.

5. The networked computer system of claim 1, wherein the profiler component comprises:
a process instantiator that executes the candidate process;
a process interactor that establishes a simple network connection with the candidate process to reveal specific file descriptors associated with the established network connection or connections; and
an artifact extractor that stores the specific file descriptors associated with the established network connection or connections to client devices so that subsequent phases are able to pinpoint particular information required for a transition to the substitution process.

6. The networked computer system of claim 5, wherein the process interactor logs system calls executed by the candidate process.

7. The networked computer system of claim 6, wherein the system calls include network socket system calls which are parsed to obtain information about listening ports and listening interface addresses.

8. The networked computer system of claim 1, wherein the checkpoint generator component creates the checkpoint by suspending the candidate process and storing all data that is required to resume the candidate process at a later time.

9. The networked computer system of claim 8, wherein the checkpoint is defined by:
a unique identifier element that matches a unique identifier specified in the candidate process;
a port element that the checkpoint utilizes for network communication;
a directive element that indicates whether checkpoint data should be overwritten if a target directory is not empty; and
a method element that identifies whether a time-based or automatic checkpoint type occurs.

10. The networked computer system of claim 8, wherein the checkpoint is defined by:
a connection element that specifies whether a network connection should gracefully close after the checkpoint;
a store element that identifies a location where checkpoint data will be stored;
a template element that identifies a location of a template that will be used to generate a script for creating the checkpoint;
a converter element that identifies a location of a software program to convert specific checkpoint files from one data interchange format to another;
a weaver element that identifies a location of the software program that transfers network socket information across checkpoints;
a script element that identifies a location where an auto-generated checkpoint execution script will reside;
a command element that isolates and extracts an identification of a running process; and
a delay element that identifies a duration before the checkpoint is selected.

11. The networked computer system of claim 8, wherein the checkpoint is defined by:
a template element that identifies a location of a template engine that will be used to generate the code for a pre-load library source file;
a first trigger element that identifies system calls that will be overridden and that will potentially checkpoint the process, depending on whether a file descriptor matches;
a second trigger element that identifies file descriptors that will be compared within system call functions to determine whether the process should be checkpointed;
a compile element that determines whether to compile a generated library if a binary already exists;
a checkpoint element that specifies, in the case of multiple system call and file descriptor matches, which iterations the checkpoints should be taken; and
a library element that identifies a location where the pre-load library source file will be stored.

12. The networked computer system of claim 1, wherein the checkpoint generator component comprises:
an environment constructor that reads file descriptors associated with an established network connection or connections to a client device complied by the profiler component and generates at least one directory that will be used to store time-based and automatic checkpoints for the candidate process;
a code generator that creates an execution script for the candidate process;
an interaction process that connects to the candidate process to checkpoint in a connected state; and
a checkpoint creator that runs the execution script for the candidate process.

13. The networked computer system of claim 10, wherein the code generator uses a template engine to create the execution script.

14. The networked computer system of claim 10, wherein the code generator creates an auto-interrupter program that overrides system call functions, which is compiled into a library that is pre-loaded into a target candidate process.

15. The networked computer system of claim 1, wherein the candidate process and the substitution process for the candidate process comprise honeypots.

16. The networked computer system of claim 13, wherein the honeypots comprise decoy devices or services or a combination thereof operating on the network that are used to lure attackers away from the predetermined data.

17. The networked computer system of claim 1, wherein the orchestrator component handles an instantiation and transition of a substitution process for the candidate process when specified conditions are met based on time or system calls.

18. The networked computer system of claim 15, wherein the orchestrator component interweaves data across processes that are needed to preserve network connections.

19. The networked computer system of claim 1, wherein the orchestrator component comprises:
a code generator that creates a switchover script for executing the substitution process for the candidate process;
a honeypot instantiator that executes the switchover script;
a trigger that analyzes the executed switchover script and determines and stores information about a current network state of the network; and
a process weaver that retrieves information regarding at least one previous target and updates a socket to match that of a current process.

20. A computer-readable medium storing instructions for automated substitution process with reserved connection capabilities, the instructions executed by a processor to:
collect information about a candidate process and generate a configuration file;
instantiate, suspend, and store information for execution of the candidate process and create a checkpoint based on the configuration file; and
receive the checkpoint and a transition configuration to manage and enact a substitution process for the candidate process for counteracting unauthorized use of predetermined data in the network while maintaining all network connections during execution of the substitution process.
